(19) United States
(12) Patent Application Publication
(10) Pub. No.: US 2024/0185254 A1
(43) Pub. Date: Jun. 6, 2024

(54) SYSTEM FOR RULES-BASED MULTI-CURRENCY SETTLEMENT

(71) Applicant: MASTERCARD INTERNATIONAL INCORPORATED, PURCHASE, NY (US)

(72) Inventor: Asha SOMAYAJULA, Eureka, MO (US)

(21) Appl. No.: 18/061,988

(22) Filed: Dec. 5, 2022

(51) Int. Cl. G06Q 20/40; G06Q 20/06

(52) U.S. Cl. CPC G06Q 20/405; G06Q 20/065

(57) ABSTRACT

Examples provide a multi-currency transaction settlement system that utilizes customizable settlement rules to select different types of currencies for use in a settlement process. When a settlement transaction request is received from a requestor, the system applies the settlement rules to identify a currency type to be used to settle the payment amount or a portion of the payment amount regardless of the initial currency type utilized by the customer completing the payment transaction. The rules are used to select a fiat currency or cryptocurrency based on attributes of the transaction, such as the location of the transaction, type of transaction, amount of the transaction, payment installments, time of the transaction, etc. The rules are user-generated to specify which currency type is used for transaction settlement based on one or more of the attributes for improved flexibility and customization of the settlement process.

### BACKGROUND

Current settlement processes allow for standard credit card purchases to be settled through a clearing process via the global clearing management system (GCMS). The process of completing a transaction typically involves authorization of the customer's payment card linked to an issuer bank, clearing of the transaction to reconcile the acquirer/merchant bank and the issuer bank, and settlement process sending payment from the issuer bank to the acquirer/merchant bank. The settlements are made using the same standard currency type presented by the customer during purchase of the goods or services. This standard currency type is typically a fiat currency, such as, dollars, pounds, euros, etc. The current exchange clearing process accommodates transaction settlements using the standard fiat transaction currency presented by the customer. The issuer cannot complete settlement using a different fiat currency or other type of currency (e.g., cryptocurrency). After settlement, a separate process for converting between currencies must occur with existing systems. This is computationally inefficient, requiring additional computing resources such as network bandwidth, processing cycles, and memory usage.

### SUMMARY

Some examples provide a system and method for multi-currency settlement of transactions. A transaction settlement request associated with a payment transaction is received from a requestor, such as a merchant or acquirer bank. The transaction settlement request includes transaction data identifying attributes of the transaction. The attributes include a transaction amount in a first currency type, such as a fiat currency or a cryptocurrency. A set of user-defined settlement rules are applied to the transaction data. A second currency type is identified for use in settling the payment transaction based on application of the set of user-defined settlement rules. The second currency type includes a fiat currency or a cryptocurrency. A portion of the payment amount is settled in the second currency type.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for multi-currency settlement transactions using multiple different currency types.

FIG. 2 is an exemplary block diagram illustrating a system for applying user-generated settlement rules in multi-currency settlement transactions.

FIG. 3 is an exemplary block diagram illustrating a system for selecting a currency type for settling a transaction amount using customizable settlement rules.

FIG. 4 is an exemplary block diagram illustrating a selection manager 136 applying settlement rules to transaction data for multi-currency settlement of transactions.

FIG. 5 is an exemplary block diagram illustrating a selection manager 136 selecting different currency types to settle transactions by applying customizable settlement rules.

FIG. 6 is an exemplary block diagram illustrating user-defined settlement rules.

FIG. 7 is an exemplary flow diagram illustrating multi-currency settlement transactions.

FIG. 8 is an exemplary flow chart illustrating operation of the computing device to apply user-defined settlement rules to transaction data for multi-currency settlement transactions.

FIG. 9 is an exemplary flow chart illustrating operation of the computing device to settle transactions using selected currency types based on applicable settlement rules.

FIG. 10 is an exemplary flow chart illustrating operation of the computing device to update settlement rules.

FIG. 11 illustrates an example computing apparatus as a functional block diagram.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

Referring to the figures, examples of the disclosure enable multi-currency settlement of transactions using configurable settlement rules. In some examples, a user creates a set of settlement rules via a user interface. In some examples, the user is a merchant. In other examples, the user is an issuer of a payment card or other payment resource. The settlement rules are used to select a currency type from a variety of available currency types to be used to settle a transaction. The settlement rules can be updated dynamically to increase flexibility and adaptability of the system for merchants and issuers. The system enables multi-currency settlement in that multiple currencies are involved and, in some examples, the settlement may also be referred to as cross-currency.

In other examples, a user interface is provided to enable the user to create the settlement rules. The user configures rules which are used to determine which currency type is to be used for settlement based on transaction attributes, such as, but not limited to, transaction amount, location of the transaction, merchant type, transaction type, date/time of the transaction, or any other attributes of the transaction. This enables improved user efficiency via the user interface and reduces the number of user interactions with the system during settlement processing.

Other examples apply customized settlement rules to transaction data obtained in a transaction settlement request associated with a payment transaction received from a requestor. The requestor is the merchant or acquirer requesting settlement. The rules enable multi-currency settlement of transactions in which attributes of a transaction are evaluated using criteria associated with user-configured settlement rules to choose a different currency type for settlement. This provides increased user control over the settlement process while enabling greater flexibility and adaptability of the settlement process.

Other aspects of the examples provide a selection manager 136 that identifies a second currency type for use in settling a portion of the payment transaction using the set of settlement rules applied to the transaction data using a set of settlement rules. The second currency type can be a fiat currency or a cryptocurrency. This enables transactions begun by a customer presenting a fiat currency to be settled using either a different fiat currency or a cryptocurrency (as specified by the merchant or issuer) rather than settling the transaction using the same type of currency originally presented by the customer. This provides improved options and variety of currencies for settlement.

In yet other examples, the set of user-defined rules are applied to automatically identify a settlement currency which differs from the type of currency offered by the customer to complete the transaction. The set of rules enables the system to identify the settlement currency more rapidly and efficiently with reduced resource usage. It further reduces processor usage and network usage by simplifying identification of a settlement currency type and reducing the number of user touchpoints occurring during settlement process.

In still other aspects, a selection manager 136 configures at least a portion of the payment amount to be settled in a different currency type than the original currency type presented by the customer during the authorization phase of the transaction. The portion of the payment amount can represent all of the payment amount (total amount) or part of the payment amount. This enables the issuer to customize the settlement process rather than being limited to the standard currency type or the original currency type presented by the customer.

The issuer computing system operates in an unconventional manner at least by applying customizable settlement rules to transaction requests received from an acquirer computing system. In this manner, the issuer system is enabled to customize selection of settlement currency types based on one or more attributes of each transaction. This provides improved resource efficiency and greater flexibility of options via the multi-currency settlement for both the issuer and the customer, thereby improving functioning of the underlying computing device. Further, the disclosure increases computational efficiency by avoiding the need for a separate, additional, currency conversion post-settlement.

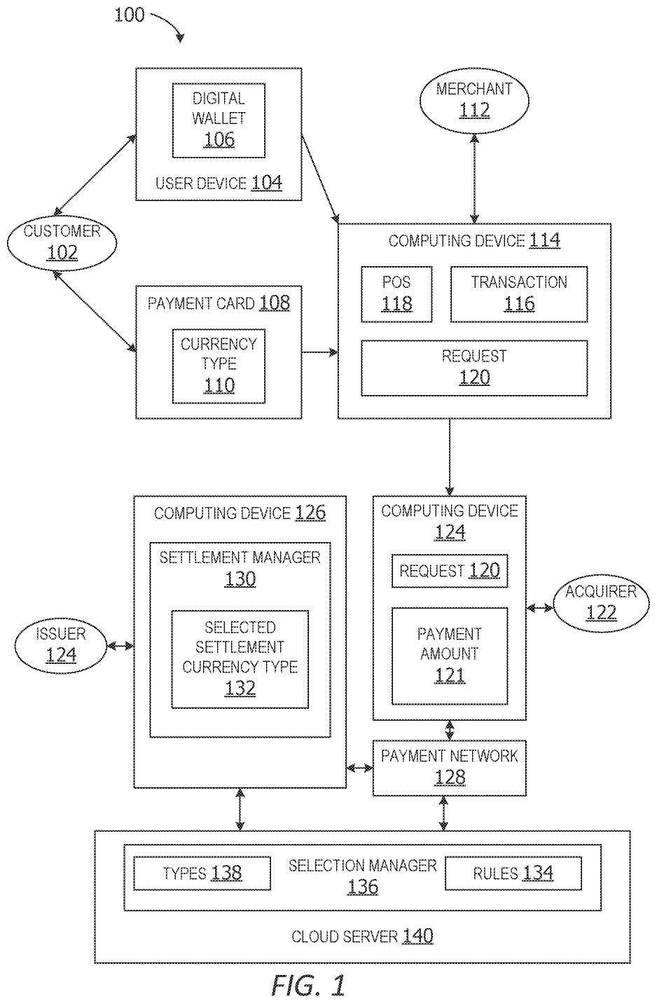

Referring again to FIG. 1, an exemplary block diagram illustrates a system 100 for multi-currency settlement transactions using multiple different currency types. In some examples, a customer 102 initiates payment of a purchase transaction by submitting a method of payment, such as a user device 104 hosting a digital wallet 106 and/or a payment card 108. The customer 102 may also be referred to as a consumer or purchaser. The user device 104 is a mobile computing device having a processor and/or a memory. The user device 104 is implemented as a smart phone, tablet computing device, smart watch, smart glasses, or any other type of mobile computing device.

The digital wallet 106 is an application that stores financial transaction payment information associated with a payment account. The payment account is an account, such as, but not limited to, a bank account, credit card account, cryptocurrency account, rewards account, or any other type of payment account. The payment card 108 is a physical payment card associated with a payment account, such as, but not limited to, a credit card, debit card, rewards membership card, or any other type of payment card. The payment card 108 can include a magnetic strip, a chip card, a contactless payment card using near field communications (NFC), or any other type of payment card. The payment card and/or the digital wallet are presented for payment to compete a transaction 116 using a currency type 110 at a merchant.

The currency type 110 is a fiat currency or a cryptocurrency. Fiat currency is a government issued currency that is typically not backed by a commodity, such as gold or silver. Fiat currency can include, without limitation, dollars, euros, pounds, yuan, yen, or any other fiat currency. Cryptocurrency is a digital currency supported on a distributed ledger technology, such as blockchain. Examples of blockchains support, without limitation, Bitcoin™, Ethereum™, etc.

In some examples, the customer presents a payment amount to complete a transaction at a point-of-sale (POS) 118 device, such as a staffed checkout or self-checkout POS device. In other examples, the customer 102 presents the payment amount via the user device 104 either in person or via a remote or online purchase process.

The merchant computing device 114 sends a settlement request 120 to an acquirer 122 computing device 126. The acquirer 122 in this example is an acquirer bank or other financial institution associated with the merchant 112. The acquirer computing device 126 sends the request 120 to an issuer 124 computing device 126 requesting settlement of the payment amount 121 via a payment network 128. The payment network 128 is an electronic payment network that handles electronic funds transfers.

The issuer 124 is an issuer of the payment card or digital wallet 106, such as a bank. The issuer computing device 126 includes a settlement manager 130 software component. The settlement manager 130 receives the settlement request from the acquirer 122 system. The settlement manager 130 requests a selected settlement currency type 132 from a selection manager 136. The settlement manager 130 receives the selected settlement currency type 132 from the selection manager 136. The settlement manager 130 completes the settlement of the transaction with the acquirer 122 using funds in the selected settlement currency type 132.

In some examples, the selection manager 136 is a software component which receives transaction data, including the request for the selected settlement currency type 132, is received from the settlement manager 130 via the payment network 128. The selection manager 136 identifies one or more selected settlement currency types, such as the selected settlement currency type 132, from a plurality of available currency types 138. The available currency types 138 can include one or more fiat currencies and/or one or more cryptocurrencies.

In this example, the selection manager 136 applies user-configured settlement rules 134 to transaction data associated with the transaction 116 to identify the selected settlement currency type 132 from a plurality of available currency types. The payment amount 121 in the selected settlement currency type is submitted to the acquirer 122 in settlement of the transaction. The payment amount 121 in some examples is submitted in its entirety via the selected settlement currency type 132. In other examples, a portion of the payment amount 121 is submitted for settlement in the selected settlement currency type 132, while another portion of the payment amount is submitted for settlement in a different currency type.

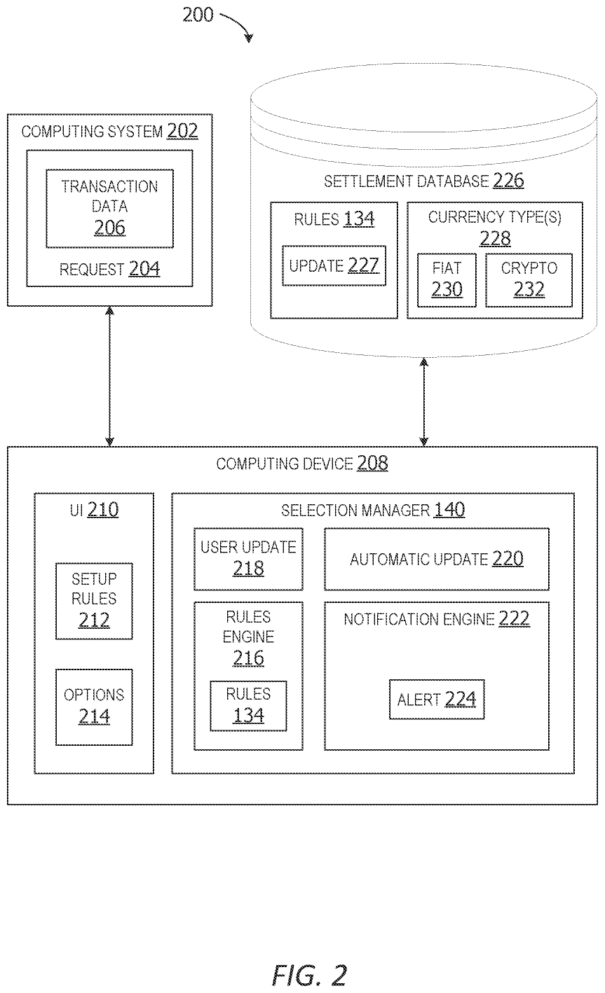

In this example, the selection manager 136 is hosted on a cloud server. The cloud server 140 is a logical server providing services to the computing device 126 or other clients, such as, but not limited to, the computing device 114. In some non-limiting examples, the cloud server 140 is associated with one or more physical servers in one or more data centers. In other examples, the cloud server 140 is associated with a distributed network of servers. However, in other examples, the selection manager 136 is hosted on a computing device associated with the merchant or issuer, such as, but not limited to, the computing device 114 and/or the computing device 126, as shown in FIG. 2 below.

In other examples, the system processes settlement of at least a portion of the payment amount in a second currency type that is different from a first currency type utilized by the customer at the POS or other payment device. The system configures at least a portion of the payment amount to be settled in the second currency type. In this manner, the computing device or other server associated with the issuer is configured to settle at least a portion of the payment account in the second currency type.

Turning to FIG. 2, an exemplary block diagram illustrating a system for applying user-generated settlement rules in multi-currency settlement transactions is shown. A computing system 202 associated with an acquirer transmits or otherwise communications a transaction settlement request 204. The computing system 202 is a computing device, such as, but not limited to, the computing device 114 in FIG. 1.

The request 204 includes transaction data 206. The transaction data 206 is data associated with a transaction to purchase goods or services. The transaction can also be a transaction to rent, lease, or otherwise obtain goods, services, accommodations, travel, etc. The transaction data includes information such as, but not limited to, the location of the transaction, location of the merchant, payment amount, type of transaction, merchant identity (ID), customer ID, type of currency presented by the customer, data of the transaction, time of the transaction, etc. In this example, the request 204 is sent via a payment network, such as the payment network 128 in FIG. 1.

The computing device 208 is a computing device associated with an issuer of a payment device, such as a payment card or digital wallet associated with a user device. The computing device 208 includes a user interface (UI) 210. A user, such as a merchant or issuer, utilizes the UI to setup rules 212, such as, the settlement rules 134 in FIG. 1. In some examples, the UI provides options 214 enabling the user to select pre-generated rules which can be customized based on user preferences. In other examples, the user can create rules from a template or using suggested rules formats.

A rules engine 216 is a software component associated with the selection manager 136 that manages and applies the rules 134 to transactions to identify a currency type for use in settling each transaction. A user update 218 to the rules can be made to dynamically update the rules. The selection manager 136 in other examples performs an automatic update 220 of the rules with or without user input. In an example, the selection manager 136 generates a rules 134 update 227 recommendation, which the user can accept or decline. If the user accepts the recommendation, the selection manager 136 performs the automatic update 220 of the rule. If the user rejects the recommendation, the rules 134 are not updated or modified.

The selection manager 136 in other examples includes a notification engine 222 software component. The notification engine 222 optionally generates an alert 224 or other notification to the user indicating a recommendation to update a rule, a notification that a rule has expired or that a rule is about to expire. The alert is presented to the user via the UI 210. In other examples, the alert 224 is sent to a user device associated with the user via a network.

The system 200 optionally includes a settlement database 226 for storing settlement-related data and/or transaction-related data. In this example, the settlement database 226 stores the rules 134 and/or the currency type(s) 228. The currency type(s) 228 includes fiat 230 currencies and crypto 232 currencies. In other examples, the settlement database 226 can optionally include transaction data, historical rules data, as well as any other data. The settlement database 226 can be stored on a data storage device, a data store, or a cloud storage.

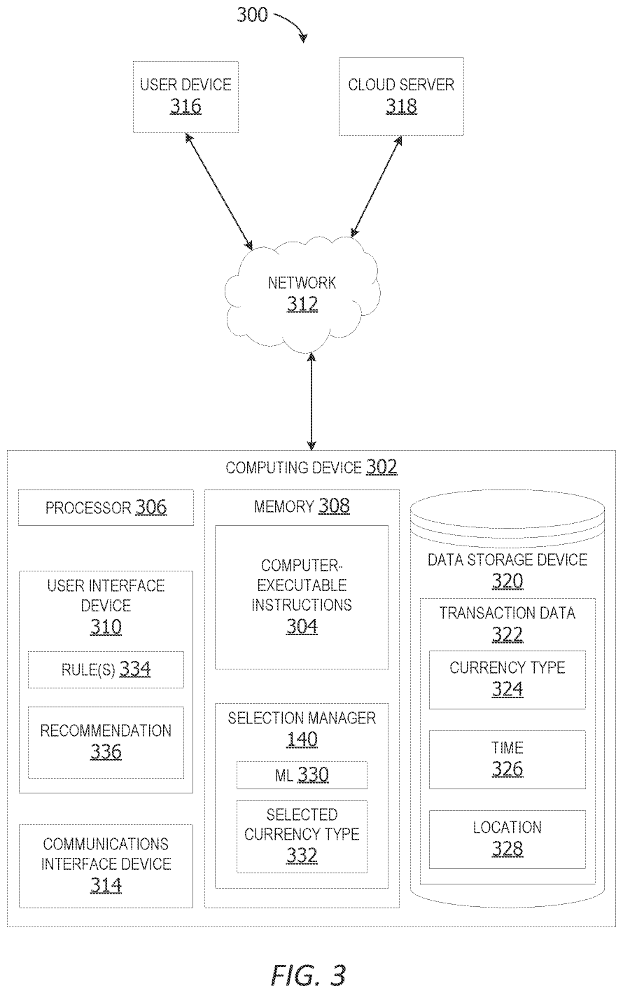

Referring now to FIG. 3, a system 300 for selecting a currency type for settling a transaction amount using customizable settlement rules. The computing device 302 is a device, such as, but not limited to the computing device 126 in FIG. 1 and/or the computing device 208 in FIG. 2.

In the example of FIG. 3, the computing device 302 represents any device executing computer-executable instructions 304 to implement the operations and functionality associated with the computing device 302. The computer-executable instructions can optionally include, for example, application programs, operating system functionality, or both.

The computing device 302 in some examples includes a mobile computing device or any other portable device. A mobile computing device includes, for example but without limitation, a mobile telephone, laptop, tablet, computing pad, netbook, gaming device, and/or portable media player. The computing device 302 can also include less-portable devices such as servers, desktop personal computers, kiosks, or tabletop devices. Additionally, the computing device 302 can represent a group of processing units or other computing devices.

In some examples, the computing device 302 has at least one processor 306 and a memory 308. The computing device 302 in other examples includes a user interface device 310.

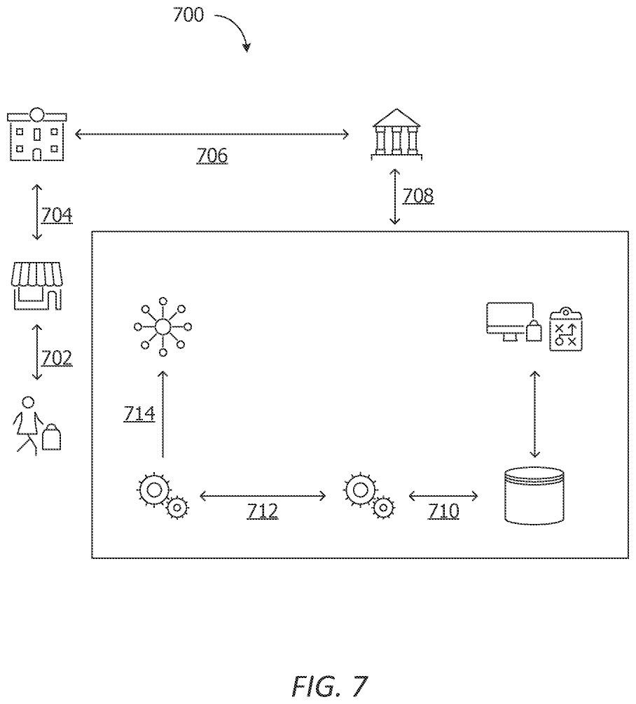

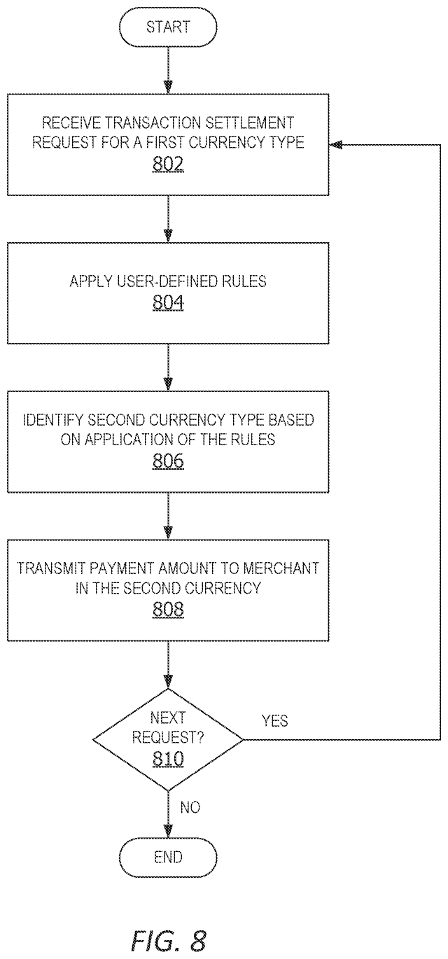

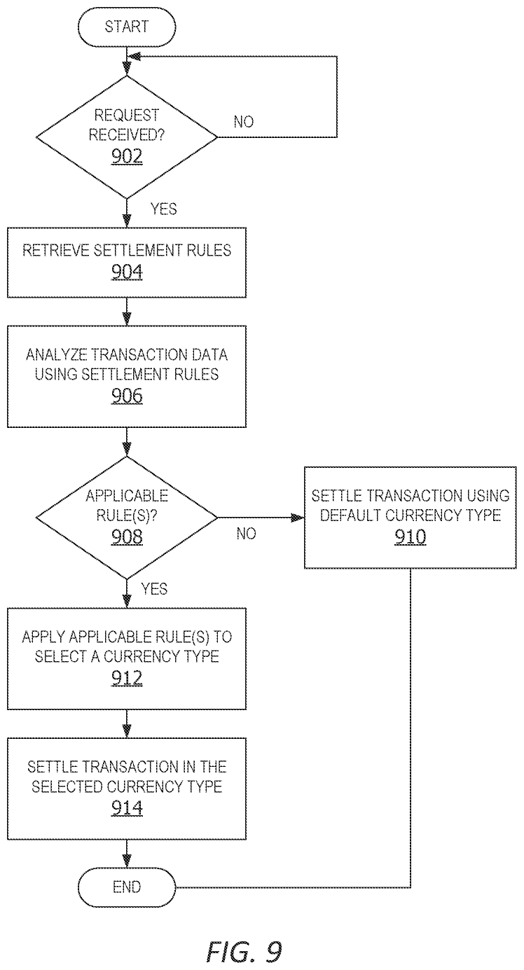

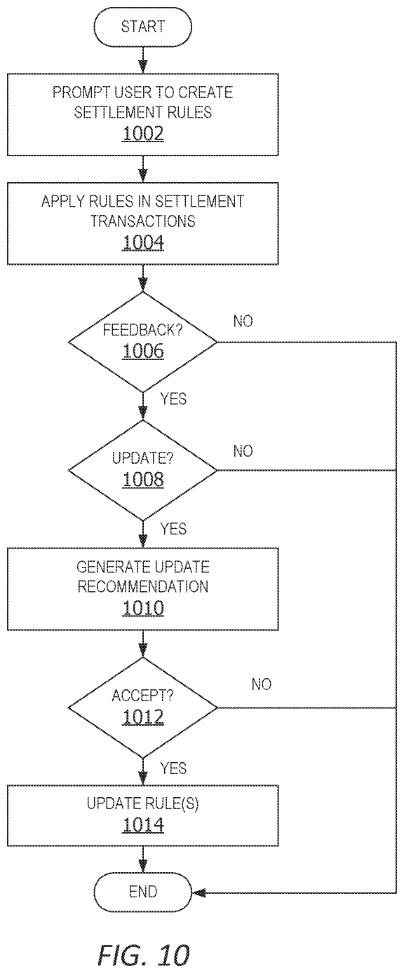

The processor 306 includes any quantity of processing units and is programmed to execute the computer-executable instructions 304. The computer-executable instructions 304 is performed by the processor 306, performed by multiple processors within the computing device 302 or performed by a processor external to the computing device 302. In some examples, the processor 306 is programmed to execute instructions such as those illustrated in the figures (e.g., FIG. 7, FIG. 8, FIG. 9, and FIG. 10).

The computing device 302 further has one or more computer-readable media such as the memory 308. The memory 308 includes any quantity of media associated with or accessible by the computing device 302. The memory 308 in these examples is internal to the computing device 302, as shown in FIG. 3. In other examples, the memory 308 is external to the computing device (not shown) or both (not shown). The memory 308 can include read-only memory and/or memory wired into an analog computing device.

The memory 308 stores data, such as one or more applications. The applications, when executed by the processor 306, operate to perform functionality on the computing device 302. The applications can communicate with counterpart applications or services, such as web services accessible via a network 312. In an example, the applications represent downloaded client-side applications that correspond to server-side services executing in a cloud.

In other examples, the user interface device 310 includes a graphics card for displaying data to the user and receiving data from the user. The user interface device 310 can also include computer-executable instructions (e.g., a driver) for operating the graphics card. Further, the user interface device 310 can include a display (e.g., a touch screen display or natural user interface) and/or computer-executable instructions (e.g., a driver) for operating the display. The user interface device 310 can also include one or more of the following to provide data to the user or receive data from the user: speakers, a sound card, a camera, a microphone, a vibration motor, one or more accelerometers, a BLUETOOTH® brand communication module, global positioning system (GPS) hardware, and a photoreceptive light sensor. In a non-limiting example, the user inputs commands or manipulates data by moving the computing device 302 in one or more ways.

The network 312 is implemented by one or more physical network components, such as, but without limitation, routers, switches, network interface cards (NICs), and other network devices. The network 312 is any type of network for enabling communications with remote computing devices, such as, but not limited to, a local area network (LAN), a subnet, a wide area network (WAN), a wireless (Wi-Fi) network, or any other type of network. In this example, the network 312 is a WAN, such as the Internet. However, in other examples, the network 312 is a local or private LAN.

In some examples, the system 300 optionally includes a communications interface device 314. The communications interface device 314 includes a network interface card and/or computer-executable instructions (e.g., a driver) for operating the network interface card. Communication between the computing device 302 and other devices, such as but not limited to a user device 316 and/or a cloud server 318, can occur using any protocol or mechanism over any wired or wireless connection. In some examples, the communications interface device 314 is operable with short range communication technologies such as by using near-field communication (NFC) tags.

The user device 316 represents any device executing computer-executable instructions. The user device 316 can be implemented as a mobile computing device, such as, but not limited to, a wearable computing device, a mobile telephone, laptop, tablet, computing pad, netbook, gaming device, and/or any other portable device. The user device 316 includes at least one processor and a memory. The user device 316 can also include a user interface component. In this example, the user device 316 is a device associated with a customer performing a transaction which is being settled by the selection manager 136.

The cloud server 318 is a logical server providing services to the computing device 302 or other clients, such as, but not limited to, the user device 316. The cloud server 318 is hosted and/or delivered via the network 312. In some non-limiting examples, the cloud server 318 is associated with one or more physical servers in one or more data centers. In other examples, the cloud server 318 is associated with a distributed network of servers.

The system 300 can optionally include a data storage device 320 for storing data, such as, but not limited to transaction data 322 associated with at one or more transactions. The data storage device 320 can include one or more different types of data storage devices, such as, for example, one or more rotating disks drives, one or more solid state drives (SSDs), and/or any other type of data storage device. The data storage device 320 in some non-limiting examples includes a redundant array of independent disks (RAID) array. In other examples, the data storage device 320 includes a database, such as, but not limited to, the settlement database 226 in FIG. 2.

The data storage device 320 in this example is included within the computing device 302, attached to the computing device, plugged into the computing device, or otherwise associated with the computing device 302. In other examples, the data storage device 320 includes a remote data storage accessed by the computing device via the network 312, such as a remote data storage device, a data storage in a remote data center, or a cloud storage.

The transaction data 322 is data associated with a transaction, such as, but not limited to, a transaction to purchase goods and/or services provided by a merchant. The transaction data 322 describes attributes of the transaction, such as, but not limited to, a currency type 324 of the currency presented by the customer for payment, a time 326 of the transaction and/or a location 328 where the transaction takes place. The location 328 can be the location of the customer and/or the location of the merchant. In some cases, where the customer is making a purchase in-person at a merchant's place of business, the location 328 is the location of both the merchant's place of business or retail store and the location of the customer.

In this example, the memory 308 stores the selection manager 136. The selection manager 136 optionally includes a machine learning (ML) 330 component. The machine learning 330 component may include pattern recognition, modeling, or other machine learning algorithms to analyze the transaction data 322 using the rule(s) 334 to identify a selected currency type 332 for settlement and/or generate alerts, including notifications and/or recommendation(s) 336 to update the rule(s) 334.

The rule(s) 334 include one or more user-defined settlement rules for identifying a type of currency to be used by an issuer in a transaction settlement with an acquirer. The rule(s) 334 in some examples include rules, such as, but not limited to, the rules 134 in FIG. 1 and FIG. 2. The user-defined settlement rule(s) 334, in some examples, include rule(s) defined by a merchant or issuer for use in selecting a currency type from a plurality of currency types available for use in settlement.

In some examples, the machine learning 330 uses the data stored in one or more databases with historical rules data to learn how to optimize the settlement rules for optimization of settlement currency selection for different types of transactions.

In still other examples, the selection manager 136 performs a conversion of the payment amount in the first currency type to an equivalent payment amount in the second currency type. For example, if the customer makes a purchase transaction for a payment amount of one hundred dollars ($100) in fiat currency but the settlement rules indicate the transaction should be settled using a cryptocurrency, the selection manager 136 calculates how much cryptocurrency is equivalent to the one hundred dollars. This transaction is then settled in the second currency type (cryptocurrency) in the calculated amount that is equivalent to the original transaction payment amount. This can be referred to as a conversion or translation operation to calculate a second payment amount in the second currency type.

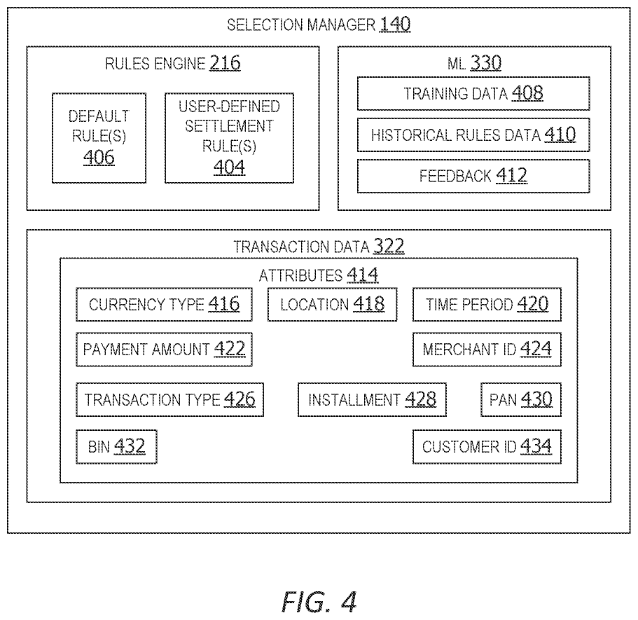

FIG. 4 is an exemplary block diagram illustrating a selection manager 136 applying settlement rules to transaction data for multi-currency settlement of transactions. In some examples, the selection manager 136 includes a rules engine 216. The rules engine 216 manages a set of settlement rules 402. The set of settlement rules 402 includes one or more settlement rules 404, such as, but not limited to, the rules 134 in FIG. 1, the rules 134 in FIG. 2 and/or the rule(s) 334 in FIG. 3.

In this example, the set of settlement rules 402 also includes one or more default rule(s) 406. The default rule(s) 406 are used to identify a settlement currency where the customizable set of settlement rules are inapplicable. For example, if the set of settlement rule(s) specify that a particular cryptocurrency is to be used to settle transactions with a specific identified merchant A and there are no other settlement rules, then any transaction involving a merchant other than the identified merchant A is governed by the default rule(s) 406. The default rule(s) 406 in this example specify a default currency type to be used for settlement, such as a standard currency or the currency originally presented by the customer at the POS.

The ML 330 in some examples is trained using training data 408. In other examples, the ML 330 optionally also utilizes historical rules data 410 and/or user feedback 412 to further refine the rules generation process. In this manner, the ML 330 dynamically optimizes the rules in real-time to improve user interaction with the system and ensure successful settlement which is most likely to be suitable for all parties involved in transactions.

In other examples, the selection manager 136 analyzes transaction data 322 obtained from a settlement request. The transaction data include attributes 414. The attributes 414 in some examples includes an identification of the currency type 416 presented by the customer at the POS, location 418 of the transaction or merchant, time period 420 during which the transaction occurs, the payment amount 422 of the transaction, merchant ID 424, transaction type 426, installment 428, payment account number (PAN) 430, bank identification number (BIN) 432 and/or customer ID 434. The transaction type 426 describes what kind of transaction, such as, but not limited to, transaction for goods, transaction for services, etc.

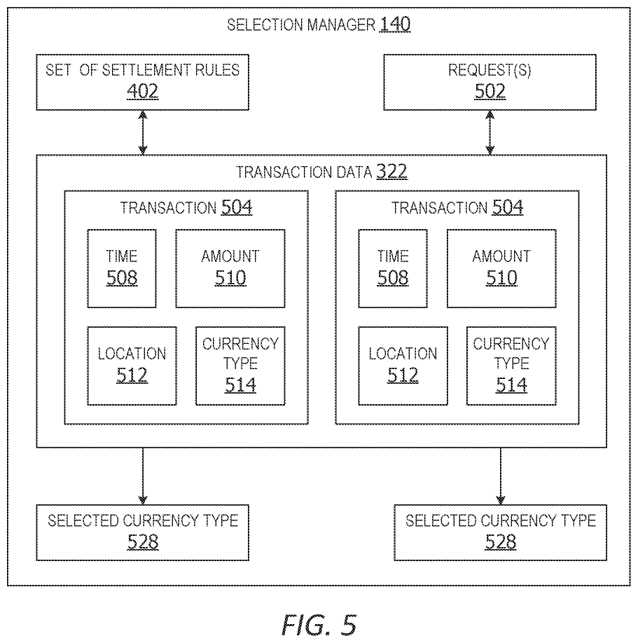

FIG. 5 is an exemplary block diagram illustrating a selection manager 136 selecting different currency types to settle transactions by applying customizable settlement rules. In this example, the selection manager 136 applies the set of settlement rules 402 to transaction data 322 obtained from settlement request(s) 502 received from one or more acquirer systems. The transaction data 322 describes attributes of transactions, such as, but not limited to, transaction 504 and transaction 506.

The transaction 504 includes a time 508 when the transaction took place, an amount 510 to be paid, a location 512, and/or a currency type 514 presented by the customer. The transaction 506 occurs at a different time 518, for a different payment amount 520. The transaction 506 may occur at a different location 522 or at the same location as transaction 504. The transaction 506 may include the same original currency type 514 presented by the customer or a different currency type 524. For example, the customer may present a first currency type 514 in a fiat currency for transaction 504 but present a different currency type 524 in a cryptocurrency for the second transaction 506.

The selection manager 136 applies the set of settlement rules 402. Due to differences in the attributes associated with each transaction, the selection manager 136 may identify a different settlement currency to be used to settle each transaction. Thus, in this example, the selected currency type 528 for the first transaction 504 is a different selected currency type 530 for the second transaction 506. However, the examples are not limited to different currency types for each transaction. In one example, all transactions occurring within the same time period or at the same location may be settled using the same selected currency type.

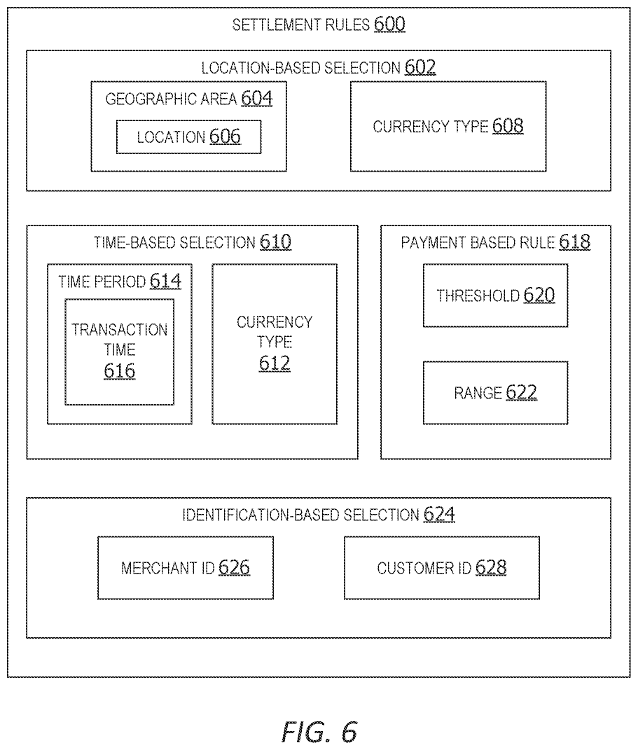

FIG. 6 is an exemplary block diagram illustrating user-defined settlement rules 600. The user-defined settlement rules 600 include one or more rules for selecting a currency type to be used in a settlement transaction. The user-defined settlement rules 600 can include rules, such as, but not limited to, the rules 134 in FIG. 1, the rules 134 in FIG. 2, the rules 334 in FIG. 3, and/or the set of settlement rules 402 in FIG. 4 and FIG. 5.

In some examples, the user-defined settlement rules 600 include a location-based selection 602 specifying a currency type 608 to be used for transactions occurring at a location within a specified geographic area 604. In other examples, the user-defined settlement rules 600 specify a currency type 612 to be used where a transaction time 616 occurs within a given time period 614.

In still other examples, the user-defined settlement rules 600 includes a payment-based rule 618 that assigns a given currency type for transaction settlement where a payment amount falls within a threshold 620 range 622. In other examples, a first currency type is used for transactions having a payment amount that is less than a threshold amount and a different second currency type is used for transactions having a payment amount that is greater than the threshold 620.

In still other examples, the user-defined settlement rules 600 includes an identification-based selection 624 rule that specifies a currency type based on merchant ID 626 and/or customer ID 628.

The examples are not limited to applying one rule to one attribute. In other examples, a currency type may be selected based on combinations of attributes. For example, a rule may specify that a currency type be used where a transaction falls within a given time period and occurs within a given geographic area. In another example, a rule may specify that a given currency type is used where a transaction is associated with a given merchant ID, the payment amount is within a threshold range and the transaction occurs during a given time period.

FIG. 7 is an exemplary flow diagram 700 illustrating multi-currency settlement transactions. A customer completes a purchase from a merchant at 702. The purchase can be for goods or services. The term purchase can include renting, leasing, or paying a deposit, as well as a purchase. The merchant requests settlement of the payment amount at 704. The request is sent to the issuer associated with a payment card or other payment device used by the customer as a payment method to pay a payment amount. The acquirer requests settlement of the payment amount from the issuer at 706. The settlement process routes to a rules-driven, multi-currency settlement process, such as, but not limited to, a multi-currency settlement system on a computing device or cloud server. The settlement process is routed by the issuer at 708. User-defined settlement rules can be set up to select a currency type based on payment account number (PAN), bank identification number (BIN) ranges, location, installments, time period, currency type, merchant code, etc. The rules are set up by an issuer or merchant via a settlement rules UI.

In some examples, a settlement rules application programming interface (API) retrieves settlement rules from a settlement database at 710. The settlement data is a data store, such as, but not limited to, the settlement database 226 in FIG. 2 and/or the data storage device 320 in FIG. 3. A settlement API processes the settlement rules at 712. The selection manager processes the settlement from the issuer bank at 714. The payment amount is settled by the issuer using the selected currency identified from a plurality of available currencies.

The selection of a currency type using the settlement rules can be driven by the location of the cardholder (residence or travel), PAN of cardholder, time period for reconciliation, currency conversion type, and/or installment defined for different reconciliation types. For example, the rules may specify that the third payment in a set of four installment payments should be made using a cryptocurrency. The currency conversion type refers to a fiat currency to cryptocurrency, cryptocurrency to cryptocurrency, fiat currency to fiat currency or cryptocurrency to fiat currency settlement.

In this example, the issuer sends the funds in the selected currency type to the acquirer for settlement. The acquirer sends the funds to the merchant. A confirmation is optionally provided to the issuer and/or the customer.

FIG. 8 is an exemplary flow chart illustrating operation of the computing device to apply user-defined settlement rules to transaction data for multi-currency settlement transactions. The process shown in FIG. 8 can be implemented by a selection manager 136 executing on a computing device, such as the computing device 208 in FIG. 2 and/or the computing device 302 in FIG. 3.

A transaction settlement request for a first currency type is received at 802. The request is a request from an acquirer for settlement of a payment amount associated with a transaction, such as the request 120 in FIG. 1 and/or the request 204 in FIG. 2. The transaction manager applies user-defined rules at 804. The user-defined rules include one or more rules for identifying a currency type to be used during transaction settlement, such as, but not limited to the rules 134 in FIG. 1, the rules 134 in FIG. 2, the rules 334 in FIG. 3, the set of settlement rules 402 in FIG. 4, the set of settlement rules 402 in FIG. 5 and/or the user-defined settlement rules 600 in FIG. 6.

The selection manager 136 identifies a second currency type based on application of the rules at 806. The second currency type is a different currency type than the first currency type. The second currency type can include a fiat currency or a cryptocurrency. The payment amount is settled by the issuer in the second currency type at 808. A determination is made whether a next request is received at 810. If yes, the selection manager 136 iteratively performs operations 802 through 810 until no additional settlement request are pending. The process terminates thereafter.

While the operations illustrated in FIG. 8 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 8.

FIG. 9 is an exemplary flow chart illustrating operation of the computing device to settle transactions using selected currency types based on applicable settlement rules. The process shown in FIG. 9 can be implemented by a selection manager 136 executing on a computing device, such as the computing device 209 in FIG. 2 and/or the computing device 302 in FIG. 3.

A determination is made whether a settlement request is received at 902. If yes, settlement rules are retrieved at 904. The settlement rules are rules for the issuer associated with the customers payment card, digital wallet, or other payment account. The selection manager 136 analyzes transaction data using the settlement rules at 906. The transaction data is obtained from the received request. The selection manager 136 determines if any other the rules are applicable at 908. If no, the transaction is settled using a default currency type at 910. If a rule is applicable, the applicable rule(s) are applied to select a currency type at 912. The transaction is settled in the selected currency type at 914. The process terminates thereafter.

While the operations illustrated in FIG. 9 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 9.

FIG. 10 is an exemplary flow chart illustrating operation of the computing device to update settlement rules. The process shown in FIG. 10 can be implemented by a selection manager 136 executing on a computing device, such as the computing device 208 in FIG. 2 and/or the computing device 302 in FIG. 3.

A user is prompted to create settlement rules at 1002. In some examples, the user is prompted via a user interface, such as the UI 210 in FIG. 2 and/or the user interface device 310 in FIG. 3. The selection manager 136 applies rules in settlement transactions at 1004. A determination is made whether feedback is received from a user at 1006. The feedback indicates whether currency types selected based on application of the rules are suitable for settlement of various transactions. If yes, a determination is made whether to update the rules based on the feedback at 1008. If yes, an update recommendation is generated at 1010. The recommendation may be presented to the user via a UI. A determination is made whether the user accepts the recommendation at 1012. If the user accepts, the selection manager 136 automatically updates the rule(s) at 1014. The process terminates thereafter.

While the operations illustrated in FIG. 10 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 10.

### Exemplary Operating Environment

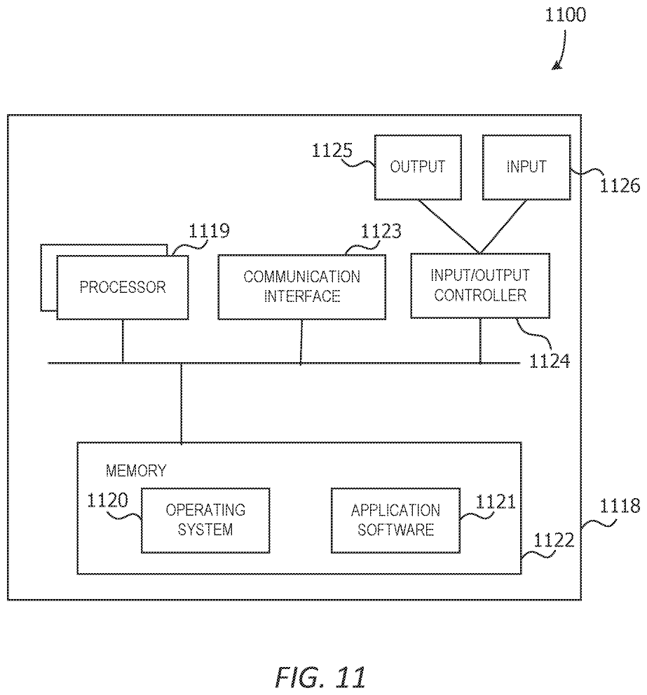

The present disclosure is operable with a computing apparatus according to an embodiment as a functional block diagram of a computing apparatus 1100 in FIG. 11. In an embodiment, components of a computing apparatus 1100 may be implemented as a part of an electronic device according to one or more embodiments described in this specification. The computing apparatus 1100 is a computing device, such as, but not limited to, the computing device 126 in FIG. 1, the computing device 208 in FIG. 2 and/or the computing device 302 in FIG. 3.

The computing apparatus 1100 comprises one or more processors 1119 which may be microprocessors, controllers, or any other suitable type of processors for processing computer executable instructions to control the operation of the electronic device. Alternatively, or in addition, the processor 1119 is any technology capable of executing logic or instructions, such as a hardcoded machine. The processor 1119 is optionally implemented as a processor such as the processor 306 in FIG. 3.

Platform software comprising an operating system 1120 or any other suitable platform software may be provided on the apparatus 1100 to enable application software 1121 to be executed on the device.

Computer executable instructions may be provided using any computer-readable media that are accessible by the computing apparatus 1100. Computer-readable media may include, for example, computer storage media such as a memory 1122 and communications media.

Computer storage media, such as a memory 1122, include volatile and non-volatile, removable, and non-removable media implemented in any method or technology for storage of information such as computer readable instructions, data structures, program modules or the like. Computer storage media include, but are not limited to, RAM, ROM, EPROM, EEPROM, persistent memory, phase change memory, flash memory or other memory technology, CD-ROM, digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In some the memory 1122 is a memory such as, but not limited to, the memory 308 in FIG. 3.

In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 1122) is shown within the computing apparatus 1100, it will be appreciated by a person skilled in the art, that the storage may be distributed or located remotely and accessed via a network or other communication link (e.g., using a communication interface 1123). The communication interface 1123 in some examples is a communication interface such as, but not limited to, the communication interface device 314 in FIG. 3.

The computing apparatus 1100 may comprise an input/output controller 1124 configured to output information to one or more output devices 1125, for example a display or a speaker, which may be separate from or integral to the electronic device. The input/output controller 1124 may also be configured to receive and process an input from one or more input devices 1126, for example, a keyboard, a microphone, or a touchpad. In one embodiment, the output device 1125 may also act as the input device. An example of such a device may be a touch sensitive display. The input/output controller 1124 may also output data to devices other than the output device, e.g., a locally connected printing device. In some embodiments, a user may provide input to the input device(s) 1126 and/or receive output from the output device(s) 1125.

The functionality described herein can be performed, at least in part, by one or more hardware logic components. According to an embodiment, the computing apparatus 1300 is configured by the program code when executed by the processor 1119 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other special purpose computing system environments, configurations, or devices.

Examples of well-known computing systems, environments, and/or configurations that may be suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure may include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example computer system comprises: at least one processor; and at least one memory comprising computer program code, the at least one memory and the computer program code configured to, with the at least one processor, cause the at least one processor to: apply a set of settlement rules to transaction data obtained in a transaction settlement request associated with a payment transaction received from a requestor, the transaction data identifying attributes of the transaction, the attributes comprising a transaction amount and a first currency type, the first currency type comprising a fiat currency or a cryptocurrency; identify a second currency type for use in settling a portion of the payment transaction using the set of user-defined settlement rules applied to the transaction data, the second currency type comprising a fiat currency or a cryptocurrency; and process at least a portion of the payment amount to be settled in the second currency type.

One or more exemplary non-transitory computer readable storage media comprise computer-executable instructions for multi-currency transaction settlement that, upon execution by a processor, cause the processor to at least: obtain transaction data from a transaction settlement request received from a requestor, the transaction data identifying attributes of the transaction, the attributes comprising a transaction amount and a first currency type, the first currency type comprising a fiat currency or a cryptocurrency; identify a second currency type for use in settling the payment transaction using a set of user-defined settlement rules applied to the transaction data, the second currency type comprising a fiat currency or a cryptocurrency. At least a portion of the payment amount is settled in the second currency type.

In some examples, the system permits a merchant to define settlement rules used to determine which currency to settle a transaction during specified time periods. Criteria used to determine which currency type to settle a transaction include, for example, timing of the rules, type of currency, region/location where it applies, specific banks, PANs, BINs, merchant types/categories, purchase amount, frequency of transactions, number of transactions with a given merchant, purchase amount, installment payment amount, number of installment payments, as well as any other attributes.

In an example scenario, a customer submits payment in cryptocurrency at the POS, but the issuer bank pays the merchant bank in Yen at a specified later date.

In another example scenario, the issuer bank settles the transaction with a portion of the transaction amount in dollars and pays the remainder of the payment amount in cryptocurrency at a later date. For example, the issuer settles today $100, but pays the rest in cryptocurrency next month.

The settlement rules can be dynamically adjustable rules based on recent purchase history (e.g., if the customer is traveling in Europe, settle in crypto during a specified date range, such as April 1 to May 31). The rules in other examples are automatically adjustable rules based on historical settlement data associated with various customers and merchants. For example, if a given merchant A preferred fiat currency rather than cryptocurrency during a previous transaction, the rules are automatically modified for that merchant to make fiat currency the selected currency type.

In still other examples, a UI is provided to enable the user to create the settlement rules. In one example, the user can drag and drop example rules into a set of rules or use a template to create the rules. The UI can be provided via a mobile user device, such as a smart phone or other mobile device.

In other examples, the system provides a platform for multi-currency settlements wherein the issuer or merchant has the ability to define options to settle in a certain currency during a specified period of time. In an example scenario the merchant decides to settle all his settlements for the month of March in Ethereum or Yen and then draw on the standard currency settlements from April to June and beyond. The platform permits flexibility to the issuer and merchant to provide inter-currency or cryptocurrency settlements using data driven settlement rules for issuers, banks and/or merchants.

In another exemplary scenario, a merchant uses a payment processor hosted application or platform to log into the merchant's account. The application provides options for the merchant to define rules for settlements made for the merchant for a given time period, such as a week, month, year, or other time period. The merchant or issuer adds a settlement rule that says, for example, from March 1 to March 20, all settlement of funds are to be made in a currency of choice, such as Ethereum or Yen. Once the settlement rule expires, the default rule of using transaction currency of settlement is applied. This provides the user with multiple different ways to settle transactions, further providing the ability to settle with multiple rules for a given time period, giving the user flexibility and increased loyalty of customers. The additional customizable options further increase transaction volume and increased usage of the platform.

In other examples, a user can specify a rule based on installment payments. In one example, a user can specify that a third installment payment for a merchant should be made in cryptocurrency while the fourth installment payment is made in the standard fiat currency.

In some examples, the settlement rules are defined or customized by a user, such as an issuer or merchant. The settlement rules can include one or more default settlement rules in addition to one or more customized rules. In other examples, the user customizes all the rules. In still other examples, the user (merchant/issuer) selects one or more of the settlement rules from a set of pre-defined settlement rules.

The selection manager, in some examples, identifies the type of currency which should be used to settle at least a portion of the payment amount. In these examples, at least a portion of the payment amount is settled in the second currency type. In these examples, the selection manager configures at least a portion of the payment amount to be settled in a second currency type (selected currency type), which is different than the first currency type submitted by the customer. A server associated with the issuer is configured to settle the portion of the payment or all of the payment using the second currency type.

In another example scenario, a customer provides payment in fiat currency, such as dollars. Due to the time and location of the transaction, the settlement rules indicate that the settlement should be made using a cryptocurrency. Therefore, the issuer bank settles payment of the transaction, either in whole or in part, using an equivalent amount of cryptocurrency or other selected currency type.

Alternatively, or in addition to the other examples described herein, examples include any combination of the following:
a user interface device, wherein the set of user-defined settlement rules are generated by a user via the user interface device;
generate a recommendation for a user to update a rule in the set of rules by a machine learning model;
present the recommendation to the user via a user interface device;
wherein the rule is automatically updated responsive to a user acceptance of the recommendation;
wherein the payment amount comprises a plurality of installment payments;
wherein the set of user-defined settlement rules further comprises a location-based rule identifying a currency type for use in completing a transaction settlement based on a location of the payment transaction;
wherein the set of user-defined settlement rules further comprises a user-defined time period associated with the second currency type;
wherein the second currency type is used to settle transactions occurring during the user-defined time period;
a rules engine applying the set of user-defined rules to the attributes identified in the transaction data to identify a currency type for settling transactions;
wherein the attributes comprises at least one of a merchant identifier, a transaction amount, a payment account number, a bank identification number, a type of transaction, a merchant type, a customer identifier, a timestamp, and a location;
receiving a transaction settlement request associated with a payment transaction from a requestor, the transaction settlement request including transaction data identifying attributes of the transaction, the attributes comprising a transaction amount and a first currency type, the first currency type comprising a fiat currency or a cryptocurrency;
applying a set of user-defined settlement rules to the transaction data;
identifying a second currency type for use in settling the payment transaction using the set of user-defined settlement rules and the transaction data, the second currency type comprising a fiat currency or a cryptocurrency;
settling at least a portion of the payment amount in the second currency type to the requestor in response to the transaction settlement request;
generating the set of user-defined settlement rules by a user via a user interface device;
generating a recommendation for a user to update a rule in the set of rules by a machine learning model;
presenting the recommendation to the user via a user interface device, wherein the rule is automatically updated responsive to a user acceptance of the recommendation;
wherein the payment amount comprises a plurality of installment payments;
wherein the set of user-defined settlement rules comprises a location-based rule;
selecting the second currency type for settlement of the portion of the payment amount responsive to a location of the payment transaction corresponding to a first geographical area in accordance with the location-based rule;
wherein the set of user-defined settlement rules further comprises a user-defined time period associated with the second currency type;
identifying a currency type for settling transactions based on the attributes;
obtain transaction data from a transaction settlement request received from a requestor, the transaction data identifying attributes of the transaction, the attributes comprising a transaction amount and a first currency type, the first currency type comprising a fiat currency or a cryptocurrency;
generate an automatic update to a rule in the set of rules by a machine learning model;
select the second currency type for settlement of the portion of the payment amount responsive to a location of the payment transaction corresponding to a first geographical area in accordance with the location-based rule;
select a third currency type for settlement of the portion of the payment amount responsive to a location of the payment transaction corresponding to a first geographical area in accordance with the location-based rule;
process settlement of at least a portion of the payment amount in the second currency type;
wherein the first currency is selected for settling a first portion of the payment amount, and the second currency is selected for settling a second portion of the payment amount;
configuring at least a portion of the payment amount to be settled in the second currency type;
wherein the second currency type is selected to settle a first portion of the payment amount at a first time period and further comprising;
selecting a third currency type to settle a second portion of the payment amount at a second time period, wherein the second time period is a different time period than the first time period;
selecting the second currency type for settlement of the portion of the payment amount responsive to a location of the payment transaction corresponding to a first geographical area in accordance with the location-based rule;
selecting a third currency type for settlement of the portion of the payment amount responsive to the location of the payment transaction corresponding to a second geographical area in accordance with the location-based rule;
selecting the second currency type for settlement of the portion of the payment amount responsive to a transaction time falling within the user-defined time period;
selecting a third currency type for settlement of the portion of the payment amount responsive to the transaction time falling outside the user-defined time period;
selecting the second currency type for settlement of the portion of the payment amount responsive to a first transaction time of a first transaction associated with the first payment amount falling within a first time period;
selecting a third currency type for settlement of the portion of the payment amount responsive to a second transaction time of a second transaction associated with the second payment amount falling within a second time period; and
selecting a third currency type for settling a second portion of the payment amount at a second time period.

At least a portion of the functionality of the various elements in FIG. 1, FIG. 2, FIG. 3, FIG. 4, FIG. 5, FIG. 6, FIG. 7 and FIG. 11 can be performed by other elements in FIG. 1, FIG. 2, FIG. 3, FIG. 4, FIG. 5, FIG. 6, FIG. 7 and FIG. 11, or an entity (e.g., processor 306, web service, server, application program, computing device, etc.) not shown in FIG. 1, FIG. 2, FIG. 3, FIG. 4, FIG. 5, FIG. 6, FIG. 7 and FIG. 11.

In some examples, the operations illustrated in FIG. 7, FIG. 8, FIG. 9, and FIG. 10 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other examples, a computer readable medium has instructions recorded thereon which when executed by a computer device cause the computer device to cooperate in performing a method of multi-currency transaction settlement, the method comprising receiving a transaction settlement request associated with a payment transaction from a requestor, the transaction settlement request including transaction data identifying attributes of the transaction, the attributes comprising a transaction amount and a first currency type, the first currency type comprising a fiat currency or a cryptocurrency; applying a set of user-defined settlement rules to the transaction data; and identifying a second currency type for use in settling the payment transaction using the set of user-defined settlement rules and the transaction data, the second currency type comprising a fiat currency or a cryptocurrency. At least a portion of the payment amount is settled in the second currency type to the requestor in response to the transaction settlement request.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

While no personally identifiable information is tracked by aspects of the disclosure, examples have been described with reference to data monitored and/or collected from the users. In some examples, notice is provided to the users of the collection of the data (e.g., via a dialog box or preference setting) and users are given the opportunity to give or deny consent for the monitoring and/or collection. The consent can take the form of opt-in consent or opt-out consent.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute exemplary means for

The term “comprising” is used in this specification to mean including the feature(s) or act(s) followed thereafter, without excluding the presence of one or more additional features or acts.

In some examples, the operations illustrated in the figures may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A multi-currency transaction settlement system, the system comprising:
at least one processor; and
at least one computer readable medium storing computer-executable instructions, which, when executed by the at least one processor, cause the at least one processor to:
apply a set of user-defined settlement rules to transaction data obtained in a transaction settlement request associated with a payment transaction received from a requestor, the transaction data identifying attributes of the transaction, the attributes comprising a transaction amount and a first currency type, the first currency type comprising a fiat currency or a cryptocurrency;
identify a second currency type for use in settling a portion of the payment transaction using the set of user-defined settlement rules applied to the transaction data, the second currency type comprising a fiat currency or a cryptocurrency; and
process settlement of at least a portion of a payment amount in the second currency type.

2. The system of claim 1, further comprising:
a user interface device, wherein the set of user-defined settlement rules are received from a user via the user interface device.

3. The system of claim 1, wherein the computer-executable instructions are further executed by the processor to cause the at least one processor to:
generate a recommendation for a user to update a rule in the set of user-defined rules by a machine learning model; and
present the recommendation to the user via a user interface device, wherein the rule is automatically updated responsive to a user acceptance of the recommendation.

4. The system of claim 1, further comprising:
a rules engine applying the set of user-defined rules to the attributes identified in the transaction data to identify a currency type for settling transactions, wherein the first currency is selected for settling a first portion of the payment amount, and the second currency is selected for settling a second portion of the payment amount.

5. The system of claim 1, wherein the set of user-defined settlement rules further comprises a location-based rule identifying a currency type for use in completing a transaction settlement based on a location of the payment transaction.

6. The system of claim 1, wherein the set of user-defined settlement rules further comprises a user-defined time period associated with the second currency type, wherein the second currency type is used to settle transactions occurring during the user-defined time period.

7. The system of claim 1, further comprising:
a rules engine applying the set of user-defined rules to the attributes identified in the transaction data to identify a currency type for settling transactions, wherein the attributes comprises one or more of the following: a merchant identifier, a transaction amount, a payment account number, a bank identification number, a type of transaction, a merchant type, a customer identifier, a timestamp, a location.

8. A method for multi-currency transaction settlements, the method comprising:
receiving a transaction settlement request associated with a payment transaction from a requestor, the transaction settlement request including transaction data identifying attributes of the transaction, the attributes comprising a transaction amount and a first currency type, the first currency type comprising a fiat currency or a cryptocurrency;
applying a set of user-defined settlement rules to the transaction data;
identifying a second currency type for use in settling the payment transaction using the set of user-defined settlement rules and the transaction data, the second currency type comprising a fiat currency or a cryptocurrency; and
configuring at least a portion of a payment amount to be settled in the second currency type.

9. The method of claim 8, further comprising:
generating the set of user-defined settlement rules based on user input via a user interface device.

10. The method of claim 8, further comprising:
generating a recommendation for a user to update a rule in the set of user-defined rules by a machine learning model; and
presenting the recommendation to the user via a user interface device, wherein the rule is automatically updated responsive to a user acceptance of the recommendation.

11. The method of claim 8, wherein the payment amount comprises a plurality of installment payments, and wherein the second currency type is selected to settle a first portion of the payment amount at a first time period and further comprising:
selecting a third currency type to settle a second portion of the payment amount at a second time period, wherein the second time period is a different time period than the first time period.

12. The method of claim 8, wherein the set of user-defined settlement rules comprises a location-based rule, and further comprising:
selecting the second currency type for settlement of the portion of the payment amount responsive to a location of the payment transaction corresponding to a first geographical area in accordance with the location-based rule; and
selecting a third currency type for settlement of the portion of the payment amount responsive to the location of the payment transaction corresponding to a second geographical area in accordance with the location-based rule.

13. The method of claim 8, wherein the set of user-defined settlement rules further comprises a user-defined time period associated with the second currency type, and further comprising:
selecting the second currency type for settlement of the portion of the payment amount responsive to a transaction time falling within the user-defined time period; and
selecting a third currency type for settlement of the portion of the payment amount responsive to the transaction time falling outside the user-defined time period.

14. The method of claim 8, further comprising:
applying the set of user-defined rules to the attributes identified in the transaction data; and
identifying a currency type for settling transactions based on the attributes, wherein the attributes comprises at least one of a merchant identifier, a transaction amount, a payment account number, a bank identification number, a type of transaction, a merchant type, a customer identifier, a timestamp, and a location.

15. The method of claim 8, further comprising:
selecting the second currency type for settlement of the portion of the payment amount responsive to a first transaction time of a first transaction associated with a first payment amount falling within a first time period; and
selecting a third currency type for settlement of the portion of the payment amount responsive to a second transaction time of a second transaction associated with a second payment amount falling within a second time period.

16. A computer storage medium having computer-executable instructions that, upon execution by a processor of a computer, cause the processor to at least:
obtain transaction data from a transaction settlement request received from a requestor, the transaction data identifying attributes of the transaction, the attributes comprising a transaction amount and a first currency type, the first currency type comprising a fiat currency or a cryptocurrency;
apply a set of user-defined settlement rules to the transaction data; and
identify a second currency type for use in settling a payment transaction using the set of user-defined settlement rules applied to the transaction data, the second currency type comprising a fiat currency or a cryptocurrency, wherein at least a portion of the payment amount is settled in the second currency type.

17. The computer storage medium of claim 16, wherein the instructions, when executed by a processor of the computer, cause the computer to further perform:
generate an automatic update to a rule in the set of rules by a machine learning model.

18. The computer storage medium of claim 16, wherein the instructions, when executed by a processor of the computer, cause the computer to further perform:
selecting a third currency type for settling a second portion of the payment amount at a second time period.

19. The computer storage medium of claim 16, wherein the instructions, when executed by a processor of the computer, cause the computer to further perform:
select the second currency type for settlement of the portion of the payment amount responsive to a location of the payment transaction corresponding to a first geographical area in accordance with a location-based rule; and
select a third currency type for settlement of the portion of the payment amount responsive to a location of the payment transaction corresponding to a first geographical area in accordance with the location-based rule.

20. The computer storage medium of claim 16, wherein the instructions, when executed by a processor of the computer, cause the computer to further perform:
selecting the second currency type for settling a first payment amount responsive to a first transaction time of a first transaction associated with the first payment amount falling within a first time period; and
selecting a third currency type for settling a second payment amount responsive to a second transaction time of a second transaction associated with the second payment amount falling within a second time period.
